(19) United States
(12) Patent Application Publication
(10) Pub. No.: US 2009/0235944 A1
(43) Pub. Date: Sep. 24, 2009

(54) NAIL FILE AND METHOD OF MANUFACTURING THE SAME

(76) Inventor: Won Wook CHA, Incheon (KR)

Correspondence Address: IPLA P.A., 3580 WILSHIRE BLVD., 17TH FLOOR, LOS ANGELES, CA, 90010, US

(21) Appl. No.: 12/239,496

(22) Filed: Sep. 26, 2008

(30) Foreign Application Priority Data
Mar. 19, 2008 (KR) 10-2008-0025539

(51) Int. Cl. A45D 29/04; B23P 25/00

(52) U.S. Cl. 132/76.4; 29/459; 29/458

(57) ABSTRACT

A nail file and a method of manufacturing the same includes a reinforcing core member made of paper, and polishing elements provided at both surfaces of the reinforcing core member with the reinforcing core member interposed therebetween and used to polish a nail surface. In the nail file and the method of manufacturing the same, the reinforcing core member is made of rigid and elastic paper, providing the nail file with higher elasticity and flexibility than conventional synthetic resin products, whereby the nail file can easily accomplish nail finishing and polishing, and can reduce environmental contamination by minimizing generation of toxins upon landfill or incineration after disposal.

### CROSS REFERENCE

This application claims foreign priority under Paris Convention and 35 U.S.C. § 119 to Korean Patent Application No. 10-2008-0025539, filed Mar. 19, 2008 with the Korean Intellectual Property Office.

### BACKGROUND OF THE INVENTION

1. Field of the Invention

The present invention relates to a stick-shaped nail file to polish nails, and more particularly, to a nail file using a reinforcing core member made of paper, which can eliminate a risk of separation or peeling from a cushion panel attached thereto by virtue of a greater adhesive force of the paper reinforcing core member than a conventional synthetic resin reinforcing core member, can achieve improved nail shaping performance due to flexibility and elasticity peculiar to paper, and can minimize environmental resource & contamination upon disposal, whereby the nail file using the recycled paper reinforcing core member is economical and eco-friendly, and a method of manufacturing the same.

2. Description of the Related Art

Generally, a nail file has been widely used as a cosmetic tool for polishing nails and glossing nail surfaces.

In a conventional method to manufacture such a nail file, after a reinforcing core member is prepared as a molded synthetic resin article, cushion panels, each made of sponge or synthetic resin foam and having a predetermined thickness, are attached to both surfaces of the reinforcing core member with the reinforcing core member interposed there between, and in turn, an abrasive panel, in which an abrasive material having a predetermined particle size is impregnated, is attached to a surface of each cushion panel.

However, the above-described conventional nail file suffers from poor flexibility and elasticity due to the use of the molded synthetic resin reinforcing core member and in particular, may be easily broken when bent beyond a predetermined angle. Further, the above-described conventional nail file has a problem of causing environmental contamination upon disposal after a lifespan thereof.

For example, upon landfill of the completely used nail file, the molded synthetic resin reinforcing core member does not undergo biodegradation even after several hundred years. On the other hand, upon incineration of the completely used nail file, a problem of air pollution via generation of poisonous gases occurs and has an adverse effect on human due to toxins emitted by the synthetic resin.

To solve the above-described problems, conventionally, a nail file, in which a wood panel is used as a reinforcing core member, has been developed. However, achieving appropriate elasticity of this product is difficult and therefore, an excessive force applied during use may easily break the resulting stick-shaped nail file. Moreover, this kind of product requires the use of expensive raw wood, resulting in increased manufacturing costs and providing an indirect cause of environmental disruption because of timbering.

### SUMMARY OF THE INVENTION

Therefore, the present invention has been made in view of the above problems, and it is an object of the present invention to provide an eco-friendly nail file, which comprises a reinforcing core member made of recycled paper, etc. and having appropriate elasticity and high strength, thereby eliminating problems due to the use of a synthetic resin or raw wood reinforcing core member, requiring minimal biodegradation time even upon landfill, and decreasing environmental contamination by minimizing generation of toxins even upon incineration after disposal, and a method of manufacturing the same.

In accordance with an aspect of the present invention, the above and other objects can be accomplished by the provision of a nail file comprising: a reinforcing core member made of a paper board; and polishing elements provided at both surfaces of the reinforcing core member with the reinforcing core member interposed therebetween and used to polish a nail surface.

Preferably, a cushion member is provided between the reinforcing core member and each polishing element, the cushion member being prepared by foaming a shock-absorbing sponge or synthetic resin.

Preferably, the polishing element includes a polishing pad having one surface coated with polishing powder, or a polishing layer formed of polishing powder adhesively coated over one surface of the reinforcing core member or the cushion member.

In accordance with another aspect of the present invention, there is provided a method of manufacturing a nail file comprising: preparing a reinforcing core member made of compressed paper; and providing at least one surface of the reinforcing core member with a polishing element used to polish a nail surface.

Preferably, the step of preparing the reinforcing core member comprises: crushing waste paper; beating the crushed waste paper; mixing the beaten waste paper with an adhesive and a hardener; press-forming the resulting mixture in a molding machine; and drying and hardening a press-formed article.

Preferably, the method further comprises: providing a cushion member, prepared by foaming a shock-absorbing sponge or synthetic resin, between the reinforcing core member and the polishing element, by use of an adhesive.

Preferably, the step of providing the reinforcing core member with the polishing element is implemented as a polishing pad having one surface coated with polishing powder is attached to the reinforcing core member or the cushion member.

Preferably, the step of providing the reinforcing core member with the polishing element is implemented as polishing powder is adhesively coated over one surface of the reinforcing core member or the cushion member so as to form a polishing layer.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 4 are perspective views illustrating different embodiments of a nail file according to the present invention; and

FIG. 5 is a block diagram explaining a process of forming a reinforcing core member for use in the nail file according to the present invention.

### DETAILED DESCRIPTION OF THE PREFERRED EMBODIMENTS

Hereinafter, preferred embodiments of the present invention will be described with reference to the accompanying drawings.

In the drawings, it is noted that the same or similar elements are denoted by the same reference numerals wherever possible. In the following description of the present invention, a detailed description of known functions and configurations incorporated herein will be omitted so as not to obscure the subject matter of the present invention.

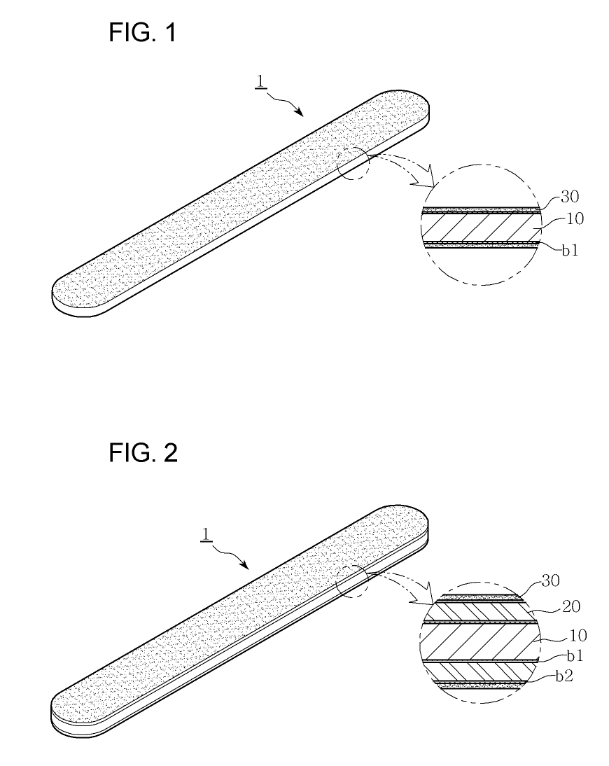

FIG. 1 is a perspective view illustrating a nail file according to a first embodiment.

As shown, the nail file 1 of the present embodiment broadly includes a reinforcing core member 10, which is made of a compressed paper board and has a predetermined thickness and length, and polishing pads 30 integrally provided at both surfaces of the reinforcing core member 10. Here, the reinforcing core member 10 and the polishing pads 30 are attached to each other by adhesive layers b1.

The nail file 1 having the above-described configuration is manufactured by preparing the reinforcing core member 10 made of compressed paper, and integrally providing at least one surface of the prepared reinforcing core member 10 with a polishing element used to polish a nail surface.

Now, the step of preparing the reinforcing core member 10 will be described.

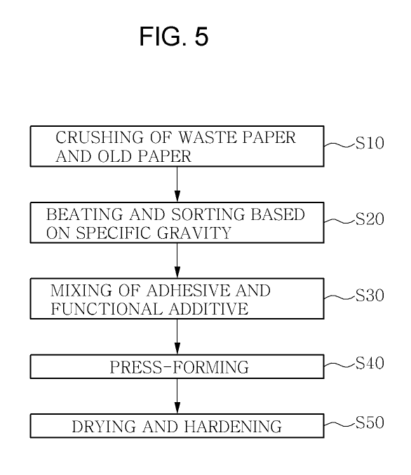

In the present invention, the reinforcing core member 10 is prepared by paper forming and thus, can minimize environmental contamination upon disposal of the nail file 1. The manufacture of the reinforcing core member 10 will be described in brief with reference to FIG. 5.

First, waste paper or old paper is crushed (S10).

Second, the crushed products, namely, the crushed waste paper or old paper is beaten (S20).

Third, functional additives, such as a water-soluble adhesive, hardener, pigment, and the like, are mixed with the beaten waste paper, to provide the waste paper with colors and antibacterial properties (S30).

Preferably, a chemical for use as the hardener is selected from natural resins such as epoxy, latex, etc.

Fourth, the resultant mixture, containing the functional additives such as the water-soluble adhesive, is introduced into a molding machine to thereby be press-formed to a desired reinforcing core member shape (S40).

Fifth, the press-formed article is dried and hardened within the molding machine, completing the forming of the reinforcing core member 10 (S50).

Next, the provision of the polishing element will be described.

The polishing element of the present embodiment includes the polishing pad 30 having a surface coated with polishing powder as shown in the drawing. The polishing pad 30 is bonded to the adhesive layer b1 coated over a surface of the reinforcing core member 10. Here, the polishing pad 30 can be implemented by a known technology and thus, a detailed description thereof will be omitted.

FIG. 2 is a perspective view illustrating a nail file according to a second embodiment of the present invention.

As shown, the nail file 1 of the present embodiment broadly includes the reinforcing core member 10, which is made of a compressed paper board and has a predetermined thickness and length, cushion members 20 integrally provided at both surfaces of the reinforcing core member 10, and the polishing pad 30 integrally provided at a surface of each cushion member 20.

Here, the reinforcing core member 10 and each cushion members 20 are attached to each other by the adhesive layer b1, and similarly, the cushion member 20 and the polishing pad 30 are attached to each other by an adhesive layer b2.

The nail file 1 having the above-described configuration is manufactured by preparing the reinforcing core member 10 made of compressed paper, providing at least one surface of the prepared reinforcing core member 10 with the cushion member 20 prepared by foaming of a shock-absorbing sponge or synthetic resin, and integrally providing a surface of the cushion member 20 with the polishing element to polish a nail surface.

Now, the step of preparing the reinforcing core member 10 will be described. In the present invention, the reinforcing core member 10 is prepared by paper forming and thus, can minimize environmental contamination upon disposal of the nail file 1. The manufacture of the reinforcing core member 10 will be described in brief with reference to FIG. 5.

First, waste paper or old paper is crushed (S10).

Second, the crushed products, namely, the crushed waste paper or old paper is beaten (S20).

Third, functional additives, such as a water-soluble adhesive, hardener, pigment, and the like, are mixed with the beaten waste paper, to provide the waste paper with colors and antibacterial properties (S30).

Preferably, a chemical for use as the hardener is selected from natural resins such as epoxy, latex, etc.

Fourth, the resultant mixture, containing the functional additives such as the water-soluble adhesive, is introduced into a molding machine to thereby be press-formed to a desired reinforcing core member shape (S40).

Fifth, the press-formed article is dried and hardened within the molding machine, completing the forming of the reinforcing core member 10 (S50).

Next, describing the provision of the cushion member 20, a predetermined amount of the adhesive layer b1 is coated over one surface or both surfaces of the prepared reinforcing core member 10. Thereafter, the shock-absorbing cushion member 20, having an area corresponding to that of the reinforcing core member 10, is integrally attached to the reinforcing core member 10.

Next, the provision of the polishing element will be described. A predetermined amount of the adhesive layer b2 is coated over the surface of the cushion member 20. Thereafter, the polishing pad 30, having an area corresponding to that of the cushion member 20, is attached to the cushion member 20. The polishing pad 30 contains polishing powder coated over one surface thereof. The polishing pad 30 can be implemented by a known technology, and a detailed description thereof will be omitted.

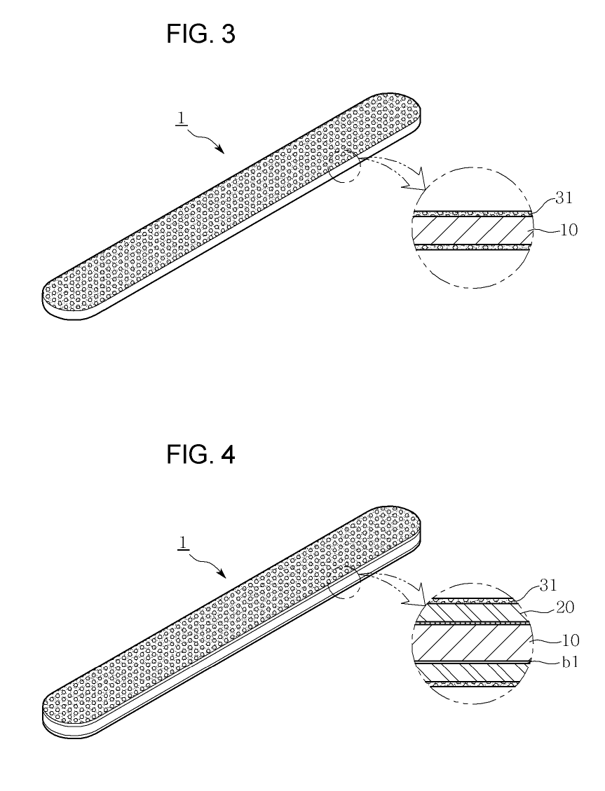

FIG. 3 is a perspective view illustrating a nail file according to a third embodiment of the present invention.

As shown, the nail file 1 of the present embodiment broadly includes the reinforcing core member 10, which is made of a compressed paper board and has a predetermined thickness and length, and polishing layers 31 integrally provided at both surfaces of the reinforcing core member 10 by coating both the surfaces of the reinforcing core member 10 with polishing powder along with an adhesive.

The nail file 1 having the above-described configuration is manufactured by preparing the reinforcing core member 10 made of compressed paper, and integrally providing at least one surface (in the present embodiment, more particularly, both surfaces) of the prepared reinforcing core member 10 with the polishing layer 31 by uniformly coating the surface of the reinforcing core member 10 with polishing powder mixed with the adhesive.

In the present embodiment, the step of preparing the reinforcing core member 10 is identical to that of the previously described first embodiment. That is, in the present invention, the reinforcing core member 10 is prepared by paper forming and thus, can minimize environmental contamination upon disposal of the nail file 1. The manufacture of the reinforcing core member 10 will be described in brief with reference to FIG. 5.

First, waste paper or old paper is crushed (S10).

Second, the crushed products, namely, the crushed waste paper or old paper is beaten (S20).

Third, functional additives, such as a water-soluble adhesive, hardener, pigment, and the like, are mixed with the beaten waste paper, to provide the waste paper with colors and antibacterial properties (S30).

Preferably, a chemical for use as the hardener is selected from natural resins such as epoxy, latex, etc.

Fourth, the resultant mixture, containing the functional additives such as the water-soluble adhesive, is introduced into a molding machine to thereby be press-formed to a desired reinforcing core member shape (S40).

Fifth, the press-formed article is dried and hardened within the molding machine, completing the forming of the reinforcing core member 10 (S50).

Next, the provision of the polishing element will be described. In the present embodiment, the polishing element, i.e. the polishing layer 31 is completed as a mixture of the adhesive and the polishing powder is uniformly coated over one surface of the reinforcing core member 10. In this case, mixing of the polishing powder and the adhesive and coating of the mixture can be implemented by known technologies, and a detailed description thereof will be omitted.

FIG. 4 is a perspective view illustrating a nail file according to a fourth embodiment of the present invention.

As shown, the nail file 1 of the present embodiment broadly includes the reinforcing core member 10, which is made of a compressed paper board and has a predetermined thickness and length, cushion members 20 integrally provided at both surfaces of the reinforcing core member 10, and the polishing layers 31 integrally provided at surfaces of the respective cushion members 20.

Here, the reinforcing core member 10 and each cushion member 20 are attached to each other by the adhesive layer b1. The polishing layer 31 is provided by uniformly coating the surface of each cushion member 20 with a mixture of the adhesive and the polishing powder.

The nail file 1 having the above-described configuration is manufactured by preparing the reinforcing core member 10 made of compressed paper, attaching the cushion member 20 having a size corresponding to that of the reinforcing core member 10 to at least one surface of the prepared reinforcing core member 10, and providing the surface of the cushion member 20 with the polishing layer 31 by uniformly coating the surface of the cushion member 20 with the mixture of the adhesive and the polishing powder.

In the present embodiment, the step of preparing the reinforcing core member 10 is identical to that of the previously described first embodiment. That is, in the present invention, the reinforcing core member 10 is prepared by paper forming and thus, can minimize environmental contamination upon disposal of the nail file 1. The manufacture of the reinforcing core member 10 will be described in brief with reference to FIG. 5.

First, waste paper or old paper is crushed (S10).

Second, the crushed products, namely, the crushed waste paper or old paper is beaten (S20).

Third, functional additives, such as a water-soluble adhesive, hardener, pigment, and the like, are mixed with the beaten waste paper, to provide the waste paper with colors and antibacterial properties (S30).

Preferably, a chemical for use as the hardener is selected from natural resins such as epoxy, latex, etc.

Fourth, the resultant mixture, containing the functional additives such as the water-soluble adhesive, is introduced into a molding machine to thereby be press-formed to a desired reinforcing core member shape (S40).

Fifth, the press-formed article is dried and hardened within the molding machine, completing the forming of the reinforcing core member 10 (S50).

Next, describing the provision of the cushion member 20, a predetermined amount of the adhesive layer b1 is coated over one surface or both surfaces of the prepared reinforcing core member 10. Thereafter, the shock-absorbing cushion member 20 having an area corresponding to that of the reinforcing core member 10 is integrally attached to the reinforcing core member 10.

Then, the provision of the polishing element will be described. The polishing element is completed as the mixture of the adhesive and the polishing powder is uniformly coated over the surface of the cushion member 20, the polishing layer 31 is completed. In this case, mixing of the polishing powder and the adhesive and coating of the mixture can be implemented by known technologies, and a detailed description thereof will be omitted.

As apparent from the above description, the present invention provides a nail file and a method of manufacturing the same having the following several effects. Firstly, in the present invention, a reinforcing core member of the nail file is made of paper having a desired rigidity and elasticity. Using the paper reinforcing core member can increase an adhesive force between the reinforcing core member, a cushion member and polishing powder and therefore, it is possible to prevent separation or peeling of the above mentioned elements. Further, providing the resulting nail file with high elasticity and flexibility is possible, whereby the nail file has no risk of breakage even if it is bent to a predetermined angle or more. As a result, the nail file of the present invention can achieve a remarkable improvement in quality and performance.

Secondly, according to the present invention, the reinforcing core member can be made of paper having a desired rigidity and elasticity via recycling of waste paper, etc., and therefore, can eliminate any problems of environmental contamination that have been caused by conventional nail files using synthetic resin or plastic reinforcing core members. Furthermore, using the waste paper can reduce manufacturing costs of products, and rapid propagation of the nail file according to the present invention can be anticipated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A nail file comprising:
a reinforcing core member made of a paper board; and
polishing elements provided at both surfaces of the reinforcing core member with the reinforcing core member interposed therebetween and used to polish a nail surface.

2. The nail file according to claim 1, wherein the polishing element includes a polishing pad having one surface coated with polishing powder, or a polishing layer formed of polishing powder adhesively coated over one surface of the reinforcing core member or the cushion member.

3. The nail file according to claim 1, wherein a cushion member is provided between the reinforcing core member and each polishing element, the cushion member being prepared by foaming a shock-absorbing sponge or synthetic resin.

4. The nail file according to claim 3, wherein the polishing element includes a polishing pad having one surface coated with polishing powder, or a polishing layer formed of polishing powder adhesively coated over one surface of the reinforcing core member or the cushion member.

5. A method of manufacturing a nail file comprising:
preparing a reinforcing core member made of compressed paper; and
providing at least one surface of the reinforcing core member with a polishing element used to polish a nail surface.

6. The method according to claim 5, wherein the step of providing the reinforcing core member with the polishing element is implemented as a polishing pad having one surface coated with polishing powder is attached to the reinforcing core member or the cushion member.

7. The method according to claim 5, wherein the step of providing the reinforcing core member with the polishing element is implemented as polishing powder is adhesively coated over one surface of the reinforcing core member or the cushion member so as to form a polishing layer.

8. The method according to claim 5, wherein the step of preparing the reinforcing core member comprises:
crushing waste paper;
beating the crushed waste paper;
mixing the beaten waste paper with an adhesive and a hardener;
press-forming the resulting mixture in a molding machine; and
drying and hardening a press-formed article.

9. The method according to claim 5, further comprising:
providing a cushion member, prepared by foaming a shock-absorbing sponge or synthetic resin, between the reinforcing core member and the polishing element, by use of an adhesive.

10. The method according to claim 9, wherein the step of providing the reinforcing core member with the polishing element is implemented as a polishing pad having one surface coated with polishing powder is attached to the reinforcing core member or the cushion member.

11. The method according to claim 9, wherein the step of providing the reinforcing core member with the polishing element is implemented as polishing powder is adhesively coated over one surface of the reinforcing core member or the cushion member so as to form a polishing layer.
